(19) United States
(12) Patent Application Publication
(10) Pub. No.: US 2008/0107267 A1
(43) Pub. Date: May 8, 2008

(54) Method for Transmitting a Digital Data File Via Telecommunication Networks

(76) Inventor: Philippe Joliot, Pont Saint Esprit (FR)

Correspondence Address: OLIFF & BERRIDGE, PLC, P.O. BOX 320850, ALEXANDRIA, VA, 22320-4850, US

(21) Appl. No.: 10/593,565

(22) PCT Filed: Mar. 16, 2005
(86) PCT No.: PCT/FR05/00635

§ 371 Date: Mar. 28, 2007

(30) Foreign Application Priority Data
Mar. 29, 2004 (FR) 0403226

(51) Int. Cl. H04L 9/06

(52) U.S. Cl. 380/259

(57) ABSTRACT

A send component (20) breaks up an initial file to be transmitted into fragments. A symbol obtained from a fragmentation-transmission key (CFT) is linked to each fragment. A transmission path within a so-called first level intermediate relay network architecture (40, 41, 42), between the send component (20) and a receive component (30), is assigned to each of the fragments generated. Following reception, the receive component (30) reassembles the fragments on the basis of the relevant data of the fragmentation-transmission key (CFT) already obtained via a so-called second level relay (10).

The present invention relates to a method for the secured and confidential transmission of digital data via an architecture of multiple and independent telecommunication or radiocommunication networks, whether in the form of static digital data, that is, data stored on any type of memory media, or dynamic digital data, that is, data that is not fixed on such media.

It is widely accepted that the mode of communication between two distant points is a single transmission channel, in which any information passes according to a transmission protocol such as TCP/IP, IKE, IPsec, UDP, and so on. Whatever the protocol chosen for this transmission, an initial block of data is routed in its entirety in the form of successive packets within a single channel. Consequently, the information in this initial block of data is entirely accessible on this transmission channel. Therefore, for a data transmission session between two distant points, at a chosen instant there is only one “single-channel” transmission convention then supported by any protocol. Thus, this single nature of the transmission convention at the chosen instant temporally and physically limits the transmission.

The present invention aims to overcome these drawbacks by providing a secured and confidential method of transmitting digital data via an architecture of multiple and independent telecommunication or radiocommunication networks, in which the initial information is not entirely accessible during its transmission, and making it possible to choose at a given instant, a transmission convention from a multitude of conventions that is far greater in number than would be allowed by simply chopping up an initial data block into individual subunits subsequently addressed to intermediate transmission relays, then forwarded to a final recipient.

To this end, the main subject of the invention is a secured and confidential method for transmitting a digital data file between a sending element and a receiving element via telecommunication or radiocommunication networks, in which;
the sending element downloads a database listing the authorized sending elements, a symmetrical fragmentation-transmission secret key;
the sending element transmits the fragmentation-transmission key to the receiving element via a so-called second-level relay;
the second-level relay informs the database that the fragmentation-transmission key is being used;
the receiving element transmits to the sending element an authorization to send fragments via the second-level relay;
the sending element fragments the data in the initial file, according to an incremental distribution before assignment by swapping, such that the data of each fragment is unintelligible, the level and the type of fragmentation being predefined in the fragmentation-transmission key;
the sending element assigns each fragment an addressing path through a so-called first-level network of relays;
the sending element transmits each fragment to the receiving element via the first-level relays;
the receiving element reassembles the fragments received, according to the instructions in the fragmentation-transmission key, to recreate the initial data file;
the receiving element sends an acknowledgement of receipt and of checking of the reassembly of the initial file to the database via the second-level relay;
the fragmentation-transmission key is deleted from the database.

Thus, the inventive idea consists in achieving a non-orthodromic, multi-temporal and multi-spatial dissemination of any data previously fragmented by the sending element, the transmission of the created fragments in an architecture of multiple and independent networks of relays, to one or more remote receiving elements which then reassemble the transmitted elements, enabling the initial data to be reconstituted in its original form.

There are advantageously defined several different classes for defining the initial information object to be transmitted, namely:
a class T of fragmentation types of the bit-by-bit, byte-by-byte, byte block-by-byte block, bit block-by-bit block, space-by-space type (for example, character feed-by-character feed, from one frequency harmonic to the reappearance of the same frequency harmonic, from one electromagnetic signal to the reappearance of the same electromagnetic signal), and therefore all possible and imaginable instances for each of the abovementioned types;
a fragmentation level class F, F being a real integer at least equal to two determined when choosing the fragmentation level;
a network size class R, R being a real integer at least equal to one, and preferably greater than or equal to two, determined when choosing the size of the network architecture;
a class A of IP addresses of the relays of the network architecture of the types of IP addresses of the so-called first-level relays, IP addresses of the so-called second-level relays, with all possible instances that can be imagined.

The principle of the invention is thus to initially implement the following characteristics;
size R of an architecture of networks of R independent first-level relays (with different IP addresses) operating in parallel;
characteristic of an independent relay (with unique IP address) assigned solely for transmitting the interchange convention between the source and the destination;
fragmentation level F of the original message by creation of F files in which the component elements of the original message are distributed by swapping;
   this in a system for generating symmetrical keys, all unique in their representation, and allowing transmission only for the network architecture described above.

Then, the data of each of these keys taken one by one (considered as a series of instructions) is implemented in a software fragmentation and sending program for generating the elements to be transmitted based on initial information. Finally, the data of the unique key is implemented after its transmission in the network architecture in a software reception and assembly program, for carrying out the instructions of the key transmitted, and obtaining from the elements transmitted and received, the initial information, while having satisfied the signature and authentication conditions of the transmission.

Depending on the size of the network architecture of independent first-level relays used, the fragmentation level and the fragmentation type (for example bit-by-bit, byte-by-byte, byte block-by-byte block, bit block-by-bit block, space-by-space, etc.) of the block of original initial data before transmission, it is thus possible to generate de facto a theoretical infinity of fragmentation-transmission keys for one and the same original initial data block between two distant entities.

In a preferred embodiment of the invention, the fragmentation-transmission key comprises two subkeys, namely;
a fragmentation-reassembly subkey, unique to each initial data file to be transmitted, and for which the counting possibilities are derived from the factorial computation, comprising the instructions needed for the deletion of the initial data file and the distribution by swapping in a set of fragments;
a sending subkey, unique to each initial data file to be transmitted, and for which the counting possibilities are derived from the exponential computation, comprising the instructions needed, such as the IP addresses of the first-level relays, for routing the fragments within the network of first-level relays.

According to one possibility, the receiving element addresses a request to the first-level relays, the IP address of which is contained in the sending subkey, to download the fragments. The setting up of a transmission session can thus be deferred in time as long as the network architecture is maintained and the right to use the fragmentation-transmission key remains valid, which ensures a confidential and physically secured archiving function.

Each of the so-called first-level relays is advantageously provided with management means for recognizing incoming fragments, intelligent sorting and forwarding the same fragments to their recipient.

The second-level relay is preferably not linked to the network of first-level relays. It is, however, possible, for example, for the second-level relay to belong to the network of first-level relays.

Depending on the degree of confidentiality required, the network of first-level relays can be dependent on the second-level relay for the definition of certain readdressing tasks.

It is possible to envisage a first- or second-level relay being replaced by three in-line relays, the intermediate relay of which is an IP address linked to the other two relays via a non-Internet connection.

overall, the method according to the invention is compatible with any type of cryptography or compression used downstream or upstream.

The invention therefore in principle opposes the currently accepted wisdom according to which, to communicate information between two distant points, only a single communication channel can be used to route all of the information.

The invention makes it possible to create an infinity of networks operating on an Internet-basis with authorized access, in which the information is interchanged in a secured and confidential manner. Each network of this infinity of networks has authorized access to the transmission session, the duration of a session being able to be limited to the processing and transmission of an item of information, or pre-established jointly by the provider of the method and the user.

Current cryptology techniques use either so-called asymmetrical encryption methods with public key and private key (for example, DES, triple DES, RSA, etc.), or so-called secret symmetrical key methods (combining steganography, masking technique, transformation-swapping techniques, and so on), all of which present, from a cryptological point of view, the following failing; whatever the power of the encryption means used, the original initial information can be accessed in its entirety and will therefore be intelligible in its entirety if a cryptanalytical attack succeeds.

From a cryptological point of view, the method according to the invention eliminates this failing, since all the original information is deconstructed before it is transmitted (or saved to a memory medium) and is not therefore all accessible while it is being transmitted (or backed up). All the original information will be made intelligible again only if all the fragments are recovered, which is made virtually impossible by the multi-temporal and multi-spatial dissemination, this recovery of all the fragments being an essential precondition to any key test in the case of a cryptanalytical attack.

In any case, the invention will be clearly understood from the description that follows, given with reference to the appended diagrammatic drawing, representing several embodiments of the method according to the invention, in which:

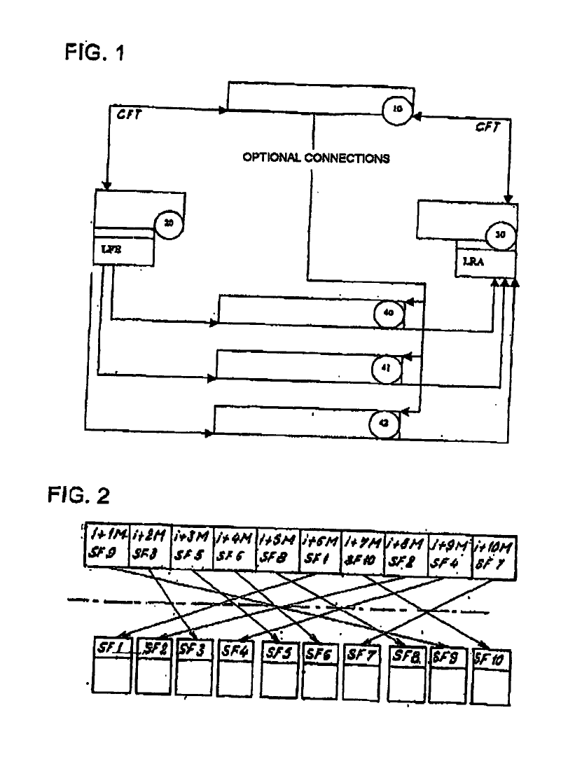

FIG. 1 is a diagram illustrating the network architectures employed;

FIG. 2 is a diagram illustrating the structure of a fragmentation-reassembly subkey;

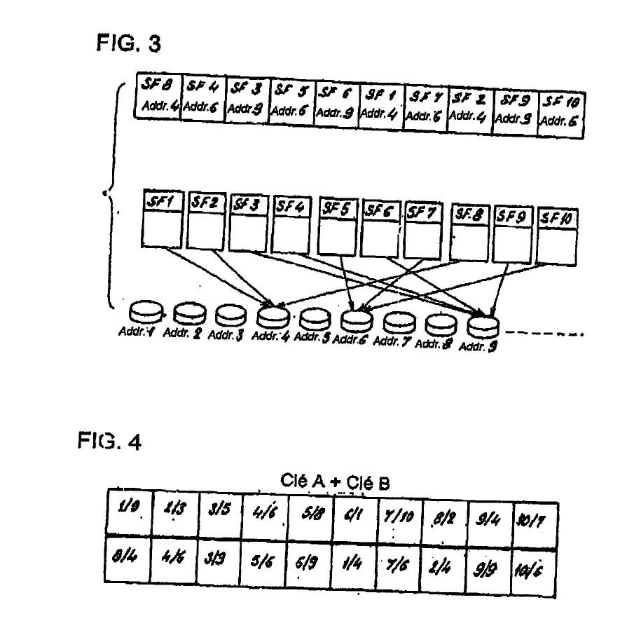

FIG. 3 is a diagram illustrating the structure of a sending subkey;

FIG. 4 is a diagram illustrating the structure of a fragmentation-transmission key;

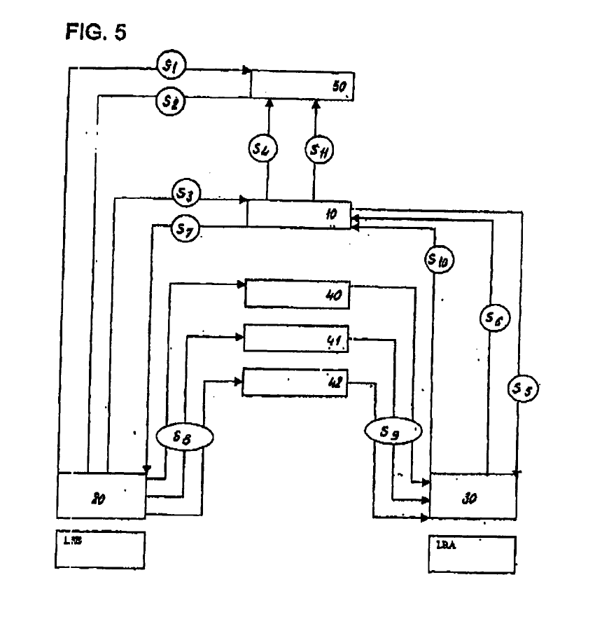

FIG. 5 illustrates an exemplary transmission session;

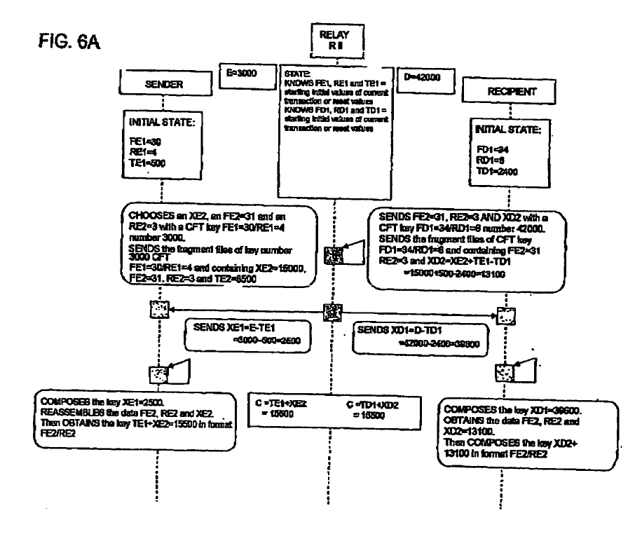

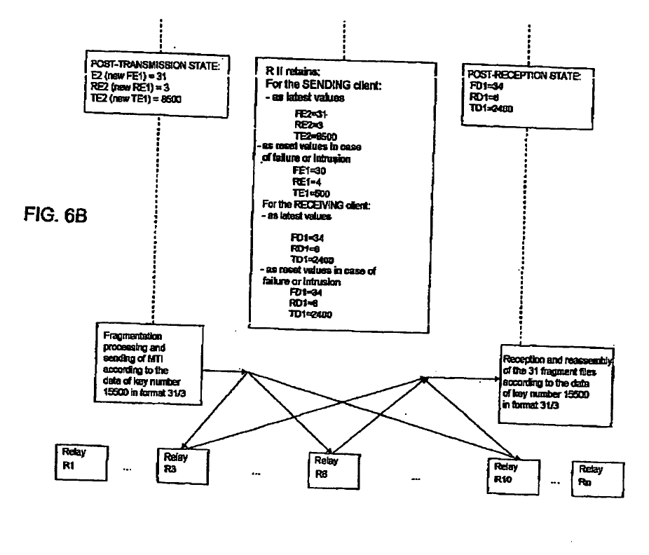

FIGS. 6A and 6B are two halves of one and the same collaboration diagram illustrating the interchanges of CFT key indices prior to processing of an initial total message MTI in a particular application of the invention.

As indicated by the diagram of FIG. 1, the network architecture is made up of two parallel independent networks.

A first network comprises a so-called “second level” relay 10, the unique function of which is to handle the transmission, between a single sender 20 and a remote recipient 30, solely of the data of a fragmentation-transmission key, called CFT file, and ensuring the unique authorization to transmit the preselected CFT key, interchanged between the sender and its recipient.

This second-level relay 10 is independent of a network of R independent relays 40, 41, 42, with pre-dedicated IP addresses, called “first level”, the unique function of which is to transmit only between the sender 20 and the recipient 30, the fragments derived from the fragmentation and the addressing data specific to each of these fragments. Each of the R first-level relays 40, 41, 42 is provided with management software for recognizing incoming fragments, intelligent sorting and forwarding the same fragments to their predefined recipient 30.

The CFT file is a symmetrical secret key that is unique for each transmission, presupplied to the device for each original initial block of data processed. It has a univalent structure with two subkeys, and its overall size is a variable dependent on the size R of the network architecture chosen and the fragmentation level F applied.

A first so-called fragmentation-reassembly subkey A contains all the instructions needed to deconstruct the original initial file and distribute it in a set of F fragments. The elements derived from the deconstruction of the original initial file are distributed in these fragments according to a swap law, the capabilities of which are derived from the equations of the factorial calculation.

A second so-called sending subkey B contains all the instructions needed to route the F fragments within the network of first-level relays.

Fragmentation and sending software LFE hosted by the sender 20 receives the instructions from the CFT file to handle on the one hand the fragmentation of the original initial message into F fragments, each of which has a size approximately F times smaller than the size of the original initial message processed. For example, for an initial message of 20 Kbytes and a fragmentation of level F=100 in byte-by-byte mode, there are 100 fragments of 200-byte size; similarly, for a very large size original initial message of 5 Gbytes and a fragmentation of size 200, there are 200 subfiles with a size of approximately 25 Mb each.

The LFE software then handles the sending of each of the fragments according to the instructions of the subkey B, to the recipient 30, predefined by the sender 20, via the network of independent first-level relays 40, 41, 42, after having first addressed the CFT file to the predefined recipient 30, via the second-level relay 10, independent of the network of first-level relays. The distribution of the F fragments within the network of first-level relays 40, 41, 42 is governed by a combination of the swap laws derived from the equations of the factorial calculation and the distribution laws for the elements of a set of F elements in a set of R elements. Each of the F fragments is accompanied only by the addressing part within the network architecture that concerns it.

Reception and assembly software, called LRA, hosted by the recipient, receives the data from the CFT file addressed via the second-level relay 10, instructions which, after comparison with the sum of certain of the relevant data routed with the F fragments, enables the LRA software to handle the reassembly of the fragments arriving at the recipient 30 via the network of first-level relays 40, 41, 42 to recreate the original initial block of data, according to the instructions in the CFT file.

The CFT file has a size and a content defined by the network architecture size parameter R and the fragmentation level F chosen for the method. Consequently, there is an interdependency link between the CFT file and the network architecture. The set of CFT files of a network has function and existence only for the network architecture for which it has been designed and, consequently, the transmission of a file processed by the fragmentation software LFE can take place only via the network architecture concerned and can reach a recipient 30 only because the transmission has been authorized in the network architecture. The existence of the CFT file assigned to a computer file prevents it being downloaded to any recipient if the transmission has not been authorized in the network architecture concerned, and reassembly impossible if the transmission has taken place other than in this network architecture.

The fragments, the subkeys A and B, the CFT file conform to any type of existing transmission protocol.

The possible predefined values of R and F for a type T (variable within a set of fragmentation type constants, predefined before applying the fragmentation method), are theoretically limited only by the size of the original initial block of data, and allow for a theoretical infinity of interchange conventions within the network architecture between the sender and the recipient. The mathematical counting laws can be used to calculate the number of interchange conventions for R and F fixed and T predefined as being equal to [(FI)²·R^{F}].

Of course, each fragment derived from the fragmentation of a block of data can itself be considered as a new original block of data and be in turn subjected to an additional fragmentation.

The number of different interchange conventions permitted by the method, for the transmission of an original file between a sender and a recipient, is [(FI)²·R^{F}] for high values of R and F.

All the data created can support the application of an encryption method of asymmetrical ciphering type with public and private key.

It is, for example, possible to define a number N of active CFT keys for a period of time D, being used to render all the transmissions of a wifi network confidential during the period D concerned.

The method according to the invention is implemented as follows.

The LFE software first applies a so-called level F fragmentation to the original initial file to be transmitted, that is, it divides the data of the original initial file incrementally into n individual subunits of size predefined by the fragmentation type (space-by-space, bit-by-bit, byte-by-byte, bit block-by-bit block or byte block-by-byte block), to thus create F groups of individual subunits divided up as evenly as possible.

An index derived from the fragmentation-reassembly subkey, the counting possibilities of which are derived from the factorial calculation, is associated with each group of the abovementioned individual subunits.

A transmission path within a network architecture of R intermediate relays between the sender and the recipient is assigned to each of the F fragments created. The counting possibilities derived from this architecture are those of the exponential calculation.

The LRA software reassembles the F fragments after they have been received by the recipient 30 according to the relevant CFT file data already acquired.

FIGS. 2 to 4 represent the structure of the CFT file.

In the fragmentation example of FIG. 2, an example given to didactically illustrate a space-by-space fragmentation type, and a fragmentation level of 10, the subkey A comprises an array of integer numbers which respectively assigns each fragment SF (subfile) the xth word of the original file.

If “i” is the increment in the file, “in this case from the first to the last word of the list”, i+1M SF9 is: the ith word of the text goes in the subfile SF9.

Thus, for the following text: “Les routeurs sont des dispositifs permettant de choisir le chemin que les datagrammes' vont emprunter pour arriver à destination. Le routage est donc le processus qui consiste à définir le chemin que vont parcourir les données d'un ordinateur A juqu'á un ordinateur B”, the fragment SF1 is “Les qua routage chemin un” and the fragment SF3 is “sont datagrammes donc vont B”.

In the exemplary structure of the subkey B in FIG. 3, Addr denotes the IP address of the first-level relays 40, 41, 42. Here, only the relays Addr4, Addr6 and Addr9 are used.

The example of FIGS. 2 and 3 is taken up again in FIG. 4 to represent the structure of the CFT file (subkey A+subkey B).

Thus, this CFT key is read as follows:

for the subkey A:

The (1st, 11th, 21st, 31st, etc.) word goes in fragment SF9;

The (2nd, 12th, 22nd, 32nd, etc.) word goes in fragment SF3;

The (3rd, 13th, 23rd, 33rd, etc.) word goes in fragment SF5;

The (4th, 14th, 24th, 34th, etc.) word goes in fragment SF6;

The (5th, 15th, 25th, 35th, etc.) word goes in fragment SF8;

The (6th, 16th, 26th, 36th, etc.) word goes in fragment SF1;

The (7th, 17th, 27th, 37th, etc.) word goes in fragment SF10;

The (8th, 18th, 28th, 38th, etc.) word goes in fragment SF2;

The (9th, 19th, 29th, 39th, etc.) word goes in fragment SF4;

The (10th, 20th, 30th, 40th, etc.) word goes in fragment SF7.

for the subkey B:

The let, 2nd and 6th fragments (SF8, SF1, SP2) go via the relay for which the IP address is the 4th of the series: the 4th, 5th, 7th and 10th fragments (SF4, SF5, SF7, SF10) go via the relay for which the IP address is the 6^{th} of the series; the 3rd, 6th and 9th fragments (SF3, SF6, SF9) go via the relay for which the IP address is the 9th of the series.

The diagram of FIG. 5 illustrates an exemplary transmission session, the steps of which are as follows.

step S1: The sender 20 requests the assignment of a CFT key. If it is already a client listed in the database 50 and the owner of a batch of reserved keys, the request is transmitted to the database 50. If it is already a client but not the owner of a batch of reserved keys, its request is processed by website back office software (not shown) before being transmitted to the database 50. Finally, if it is not a client, its request is processed by website back office software before being transmitted to the database 50 (either the purchase of a key, or the purchase of a batch of reserved keys). The request is therefore transmitted to the database 50 which extracts a CFT key that is either available from the batch of reserved CPT keys or available outside the batches of reserved CFT keys.

step S2: The CFT key chosen by the database 50 is downloaded to the sending client 20.

step S3: The CFT key is addressed by the LFE software in the CFT frame to the second-level relay 101

step S4: The second-level relay 10 informs the database 50 that the CPT key is being used and must therefore no longer be assigned but should not yet be eliminated from the database 50.

step S5: The second-level relay 10 tries to connect to the recipient 30 to send it the CFT email frame.

If the recipient 30 is connected, the CFT email frame is received in the LRA software and a message authorizing the sending of the finalized fragment frames with their relevant addressing data in the network 40, 41, 42 is prepared.

If the recipient 30 is not connected, the CFT email frame remains in the second-level relay 10 and the transmission procedure is suspended. The recipient 30 must search the second-level relay 10 for the CFT email frame as is currently done for an email. It must, however, check that no-one can be substituted for the recipient 30 by checking its IP address for example.

step S6: The message authorizing the sending of the fragment frames is transmitted to the second-level relay 10 which is the only one to know the IP address of the sender 20 of the CFT frame concerned.

step S7: The second-level relay 10 addresses the message authorizing the sending of the fragment frames to the sender 20.

If the sender 20 is connected, the sending authorization message activates the sending to the first-level relays 40, 41, 42 of the fragments created previously. If the sender 20 is not connected, it receives a message asking it to connect, and it must then search for the sending authorization message.

step S8: The fragment frames are sent to the first-level relays 40, 41, 42.

step S9: The fragment frames are forwarded by the first-level relays 40, 41, 42 to the recipient 30. If the recipient 30 is connected, the procedure continues.

If the recipient 30 is no longer connected, the first-level relays 40, 41, 42 contact the recipient 30 to connect and proceed with a new attempt to connect then send the fragment frames; a maximum number of connection-sending attempts with reasonable maximum time allowed is predetermined. In this case, the recipient 30 cannot in any circumstances search for the fragment frames that are intended for it on the first-level relays 40, 41, 42.

The reception-assembly software LRA of the recipient 30 can generate, from the CFT file data, “Request emails” with destination addresses comprising the IP addresses of the first-level relays 40, 41, 42 contained in the subkey B of the CFT file, making it possible to recover on each first-level relay 40, 41, 42 concerned, only the fragment frames identified as belonging to the transmission session of the original initial data block.

step S10: The recipient 30 sends an acknowledgement, of the ICV “Integrity Check Value” type, of receipt of the assembled message. The ICV contained in the CFT frame (therefore the initial total message) indicates that the assembly is successful.

step S11: This acknowledgement of receipt therefore validates all of the session and is transmitted to the database 50 to permanently remove the CFT key used from the list of CFT keys available.

The three parameters R (size variable of first-level network architecture), F (fragmentation level variable), T (variable within a set of fragmentation type constants, predefined before applying the fragmentation method) are mutually inseparable, that is, the existence of one leads to the existence of the other two, but they can take-values different from each other.

The combination of these three parameters defines the platform for the functions and the potential properties of the application of the method described above. The possibilities for choosing the value of each of these three parameters make it possible to obtain the preeminence of one or more of the functions and the potential properties of the application of the method, and therefore to define a set of transmission services with main properties that are significantly different and pre-oriented towards the main function or property required. It must be noted that the modulation, for example, of the parameter R, a real integer at least equal to 2, is interesting; as R reduces for a given F, the transmission cost also reduces; as R increases for a given F, the transmission cost also increases, but the security and confidentiality of transmission also increase.

All of these functions, interlinked but with mutually variable dependency links, coexisting from the application of the method, can be divided into two groups.

A first group combines the functions systematically present and not modulated by varying one of the three parameters F, R and T. These functions are:

authorizing on the network architecture only the fragments created by the method, and to prevent the routing over the network and therefore the reception by any unrecognized and unauthorized recipient of any other data not processed by the methods

ensuring the protection of the data stored on a storage medium (for example, CD, BACD, DVD, memory) and preventing the transmission and unauthorized downloading in an appropriate environment;

reducing the infectiousness and contagiousness of any virus (not being able to be exported to multiple recipients) from the moment when any transmission over the network architecture is made unique by the assignment of a unique CFT file, and any file potentially containing a virus can infect only after reassembly and execution;

limiting the scale of spamming;

ensuring that data is not repudiated.

A second group contains the functions systematically present but for which the preeminence and power can be modulated by varying one or more of the parameters F, R and T. These functions are:

handling the confidential interchange of data transmitted after applying the method;

providing a powerful (theoretically unlimited) cryptological means that is also de facto limited only by the size of the initial data block to be processed;

making it possible to transmit data with no theoretical size limit other than that imposed by the physical size of the network and the fragmentation level, without significantly increasing the transmission times

transmitting encrypted any type of data without significantly increasing the size of the initial data;

backing up and archiving encrypted any type of data.

In a more sophisticated application, the method according to the invention can be used by the sender and the recipient to generate, via their own software, the same fragmentation-transmission key so as to create a hybrid cryptosystem. To do this, the fragmentation-transmission method is applied twice in two separate phases:

a first, so-called preparation phase, during which the relevant data required for the next, so-called transaction phase, is transmitted in a secured manner by the method according to the invention, to the sender and to the recipient;

the second, so-called transaction phase, during which the data of the initial total message MTI is transmitted, in a secured manner by the method according to the invention, between the sender and the remote recipient.

During the preparation phase, there are interchanged between the second-level relay and the senders

the means for the software of the sender to generate, at the sending end, a so-called sender preparation key

the relevant data for the sender enabling it to generate at the sending end a so-called secured transaction key, this relevant data being encrypted by the sender preparation key.

During the preparation phase, there are interchanged between the second-level relay and the recipient designated by the sender:

the means for the software of the recipient to generate, at the receiving end, a so-called recipient preparation key

the relevant data for the recipient enabling it to generate the same transaction key as that used by the sender, this relevant data being encrypted by the recipient preparation key.

During the transaction phase, there is interchanged, between the sender and the recipient, the data of the initial data file MTI, encrypted according to the method by the so-called transaction key.

The software for generating the fragmentation-transmission instruction keys, software supported by the second-level relay as described previously, is located in this application, also implemented in the fragmentation-reassembly software of the sending and receiving clients.

This key generator can be used to generate the instructions of the key for which the size is defined by:

the fragmentation level F;

the size R of the network architecture used, therefore the number of first-level relays.

The generator is designed to generate, on request, any key combination ranging from the first combination to the μth combination, where μ=(FI)²·RF.

The objective is to enable the sender and the recipient to generate, by their own software, the same fragmentation-transmission key.

Each piece of software generating the fragmentation-reassembly-transmission key is characterized before use by its latest activation state, defined by the following parameters:

the fragmentation level F;

the size R of the network architecture used, that is, the number and the addresses of the first-level relays used within the network architecture;

the offset weight T of the key-generating software.

This offset weight T is a random, high-value integer number. In response to a request to generate an ith key, the key-generating software in fact generates the T+ith key.

At each instant, the database of the second-level relay knows the latest state of activation of the software of each of the authorized clients before any fragmentation-transmission.

This application is illustrated in FIGS. 6A and 6B with simple numerical examples, in practice, very large integer numbers that can be encoded on 65536 bytes can be used.

A sending client wants a secured transmittal to a recipient. It contacts the second-level relay R II.

The database of the second-level relay R II:

1°) checks that the sending client and the receiving client are registered;
2°) recovers the latest state of activation of the software of the sending client, namely FE, RE1 and TE1, and of the receiving client, namely FD1, RD1 and TD1;
3°) randomly chooses;
a) a large integer number E to generate the sender preparation key in format FE1 RE1,
b) a large integer number D to generate the recipient preparation key in format FD1 RD1,
c) a series of three large integer numbers which are assigned to the variables FE2, XE2 and TE2,
d) an integer number that is assigned to the variable RE2;
   4°) calculates the value XE1=E−TE1, that it sends uncoded to the sending client so that it can generate the sender preparation key E to proceed with reassembling the transaction instructions calculated by the second-level relay and contained in the message encrypted by this sender preparation key; this sender preparation key is in the format FE1 RE1 and in the E th rank of the software of the second-level relay and in the XE1+TE1 th rank of the software of the Bending client;
   5°) calculates the value XD1=D−FD1 that it sends uncoded to the receiving client so that it can generate the recipient preparation key D to proceed with reassembling the transaction instructions calculated by the second-level relay and contained in the message encrypted by this recipient preparation key; this recipient preparation key is in the format FD1 RD1 and in the D th rank of the software of the second-level relay and in the XD1+TD1 th rank of the software of the recipient client;
   6°) calculates the value XD2=XE2−TD1;

Then, the second-level relay

7°) applies to the data XE2, FE2, RE2 and TE2, the fragmentation defined by the E th key in format FE1 RE1 of its generator and transmits to the sending client the fragment files constructed in the network architecture;
8°) applies to the data XD2, FE2 and RE2, the fragmentation defined by the D th key in format FD1 R1 of its generator and transmits to the receiving client the fragment files constructed in the network architecture;
9°) retains in its database, as values of the latest activation state of the sending client software, the values FE2, RE2 and TE2, and as values of the latest state of activation of the software of the receiving client, the values FD1, RD1 and XD2.

The sending client software receives in turn, from the second-level relay R II, the value XE1 then the fragment files encrypted by the key of rank E in format FE1 and RE1.

The value XE1 enables the software to generate the reassembly key in format FE1 RE1 and of rank E, and thus to obtain the relevant data XE2, FE2, RE2 and TE2 which will be implemented in the software to generate the fragmentation-transmission key that will be applied to the initial data file MTI chosen to be transmitted to the receiving client.

This fragmentation-transmission key is in format FE2/RE2 of rank XE2 and constitutes the transaction key. At this stage, the fragmentation-transmission is applied a final time as explained previously according to the method of the invention to transmit the initial data file MTI to the recipients via the network architecture.

The data of the transaction key, namely the format of the fragmentation-transmission key (defined by the values FE2 and RE2 and the value TE2 transmitted in the message encrypted by the preparation key), become, for the software of the sending client, its new values defining its latest state of activation. The values of this latest state of activation will be the initial values of the preparation phase of the next application of the method described.

From the point of view of the receiving client, its software will receive in turn, from the second-level relay R II, the value XD1 then the fragment files encrypted by the key of rank D in format FD1/RD1.

The value XD1 will enable the software to generate to the reassembly key in format FD1/RD1 and of rank D, and thus to obtain the relevant data XD2, FE2, RE2, which will be implemented in the software to generate the fragmentation-transmission key that will be applied to the initial data file MTI chosen to be transmitted to the receiving client.

This fragmentation-transmission key is in format FE2/RE2 of rank XE2 and constitutes the transaction key. At this stage, the reassembly of the fragment files transmitted through the network architecture will be carried out on receiving the fragment files, and the initial data file MTI will be reconstructed by the receiving client. The values FD1, RD1 and XD2 are retained by the software of the receiving client as new values defining its latest state of activation. The values of this latest state of activation will be the initial values of the preparation phase of the next application of the method described.

It is possible to have the following operations carried out by the back office of the database of the second-level relay:

in case of failure of a transaction, resetting the activation codes of the sending client and of the receiving client to the latest values before the transaction concerned, or, at worst, to the first initialization values implemented on installation;

retaining, if necessary, in the database, the history of the values of the activation codes used by each client;

proceeding, from the second-level relay, to implement new activation values on any client for which it will be necessary, for security or other reasons, to modify the activation codes.

As can be seen, the invention is not limited just to the embodiments described above by way of examples on the contrary, it encompasses all the variants of embodiment or application. Thus, it is possible to envisage using the method that is the subject of the present invention in a secured and confidential application for archiving and backing up data on any type of memory medium (CD, SACD, DVD, SuperDVD, etc.).

1. A secured and confidential method for transmitting a digital data file between a sending element and a receiving element via telecommunication or radiocommunication networks:
the sending element downloads a database listing the authorized sending elements, a symmetrical fragmentation-transmission secret key;
the sending element transmits the fragmentation-transmission key to the receiving element via a so-called second-level relay;
the second-level relay informs the database that the fragmentation-transmission key is being used;
the receiving element transmits to the sending element an authorization to send fragments via the second-level relay;
the sending element fragments the data in the initial file, according to an incremental distribution before assignment by swapping, such that the data of each fragment is unintelligible, the level and the type of fragmentation being predefined in the fragmentation-transmission key;
the sending element assigns each fragment an addressing path through a so-called first-level network of relays;
the sending element transmits each fragment to the receiving element via the first-level relays;
the receiving element reassembles the fragments received, according to the instructions in the fragmentation-transmission key, to recreate the initial data file;
the receiving element sends an acknowledgement of receipt and of checking of the reassembly of the initial file to the database via the second-level relay;
the fragmentation-transmission key is deleted from the database.

2. The method as claimed in claim 1 wherein there are defined several different classes for defining the initial information object to be transmitted, namely:
a class T of fragmentation types of the bit-by-bit, byte-by-byte, byte block-by-byte block, bit block-by-bit block, space-by-space type, and therefore all possible instances for each of the abovementioned types;
a fragmentation level class F, F being a real integer at least equal to two determined when choosing the fragmentation level;
a network size class R, R being a real integer at least equal to one, and preferably greater than or equal to two, determined when choosing the size of the network architecture;
a class A of IP addresses of the relays of the network architecture of the types of IP addresses of the so-called first-level relays, IP addresses of the so-called second-level relays, with all possible instances.

3. The method as claimed in claim 1, wherein the fragmentation-transmission key comprises two subkeys, namely:
a fragmentation-reassembly subkey, unique to each initial data file to be transmitted, and for which the counting possibilities are derived from the factorial computation, comprising the instructions needed for the deletion of the initial data file and the distribution by swapping in a set of fragments;
a sending subkey, unique to each initial data file to be transmitted, and for which the counting possibilities are derived from the exponential computation, comprising the instructions needed, such as the IP addresses of the first-level relays, for routing the fragments within the network of first-level relays.

4. The method as claimed in claim 3, wherein the receiving element addresses a request to the first-level relays, the IP address of which is contained in the sending subkey, to download the fragments.

5. The method as claimed in claim 1, wherein each of the first-level relays is provided with management means for recognizing incoming fragments, intelligent sorting and forwarding the same fragments to their recipient.

6. The method as claimed in claim 1, wherein the second-level relay is not linked to the network of first-level relays.

7. The method as claimed in claim 1, wherein the network of first-level relays is dependent on the second-level relay for the definition of readdressing tasks.

8. The method as claimed in claim 1, wherein a first-level relay or second-level relay is replaced by three in-line relays, the intermediate relay of which is an IP address linked to the other two relays via a non-Internet connection.
